(19) United States
(12) Patent Application Publication
(10) Pub. No.: US 2025/0203620 A1
(43) Pub. Date: Jun. 19, 2025

(54) UE-INITIATED REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/970,663

(22) Filed: Dec. 5, 2024

Related U.S. Application Data
(60) Provisional application No. 63/610,251, filed on Dec. 14, 2023.
(60) Provisional application No. 63/635,078, filed on Apr. 17, 2024.
(60) Provisional application No. 63/650,265, filed on May 21, 2024.

(51) Int. Cl. H04W 72/21; H04W 24/10

(52) U.S. Cl. CPC H04W 72/21; H04W 24/10

(57) ABSTRACT

Methods and apparatuses for user equipment (UE)-initiated reporting. A method performed by a user equipment (UE) includes receiving first information indicating one or more sets of physical uplink control channel (PUCCH) resources in a PUCCH-Config and receiving second information related to one or more first PUCCH resources for transmitting a x-bit indicator to indicate transmission of a beam report. Each of the one or more sets is associated with a pucch-Resource SetId. x≥1. The method further includes determining, based at least on a value of x, a first set of PUCCH resources from the one or more sets to use for transmitting the indicator, determining, based on the first set of PUCCH resources and the second information, a first PUCCH resource to transmit the indicator, and transmitting, via the first PUCCH resource, the indicator.

### CROSS-REFERENCE TO RELATED AND CLAIM OF PRIORITY

The present application claims priority under 35 U.S.C. § 119(e) to U.S. Provisional Patent Application No. 63/610,251 filed on Dec. 14, 2023; U.S. Provisional Patent Application No. 63/635,078 filed on Apr. 17, 2024; and U.S. Provisional Patent Application No. 63/650,265 filed on May 21, 2024, which are hereby incorporated by reference in their entirety.

### TECHNICAL FIELD

The present disclosure relates generally to wireless communication systems and, more specifically, the present disclosure relates to methods and apparatuses for user equipment (UE)-initiated reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE-initiated reporting.

In one embodiment, a UE is provided. The UE includes a transceiver configured to receive first information indicating one or more sets of physical uplink control channel (PUCCH) resources in a PUCCH-Config and receive second information related to one or more first PUCCH resources for transmitting a x-bit indicator to indicate transmission of a beam report. Each of the one or more sets is associated with a pucch-ResourceSetId. x≥1. The UE further includes a processor operably coupled with the transceiver. The processor is configured to determine, based at least on a value of x, a first set of PUCCH resources from the one or more sets to use for transmitting the indicator and determine, based on the first set of PUCCH resources and the second information, a first PUCCH resource to transmit the indicator. The transceiver is further configured to transmit, via the first PUCCH resource, the indicator.

In another embodiment, a base station (BS) is provided. The BS includes a processor and a transceiver operably coupled with the processor. The transceiver is configured to transmit first information indicating one or more sets of PUCCH resources in a PUCCH-Config, transmit second information related to one or more first PUCCH resources for a x-bit indicator to indicate a beam report, and receive, via a first PUCCH, the indicator. Each of the one or more sets is associated with a pucch-ResourceSetId. x≥1. A first set of PUCCH resources from the one or more sets for the indicator is based on a value of x. The first PUCCH resource for the indicator is based on the first set of PUCCH resources and the second information.

In yet another embodiment, a method performed by a UE is provided. The method includes receiving first information indicating one or more sets of PUCCH resources in a PUCCH-Config and receiving second information related to one or more first PUCCH resources for transmitting a x-bit indicator to indicate transmission of a beam report. Each of the one or more sets is associated with a pucch-ResourceSetId. x≥1. The method further includes determining, based at least on a value of x, a first set of PUCCH resources from the one or more sets to use for transmitting the indicator, determining, based on the first set of PUCCH resources and the second information, a first PUCCH resource to transmit the indicator, and transmitting, via the first PUCCH resource, the indicator.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure; and

FIG. 7 illustrates an example method performed by a UE in a wireless communication system according to embodiments of the present disclosure.

### DETAILED DESCRIPTION

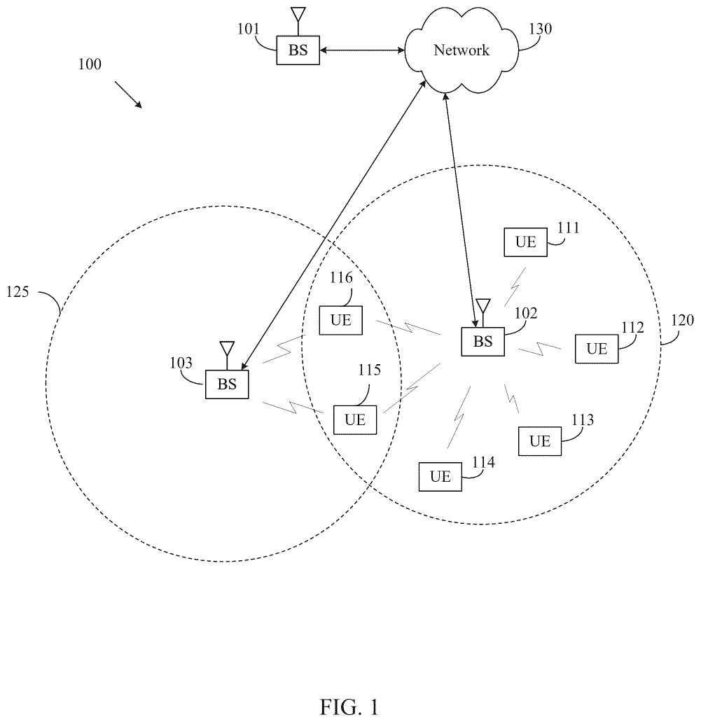

FIGS. 1-7, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for transmission of UE-initiated report. In certain embodiments, one or more of the gNBs 101-103 include circuitry, programing, or a combination thereof to support of UE-initiated reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

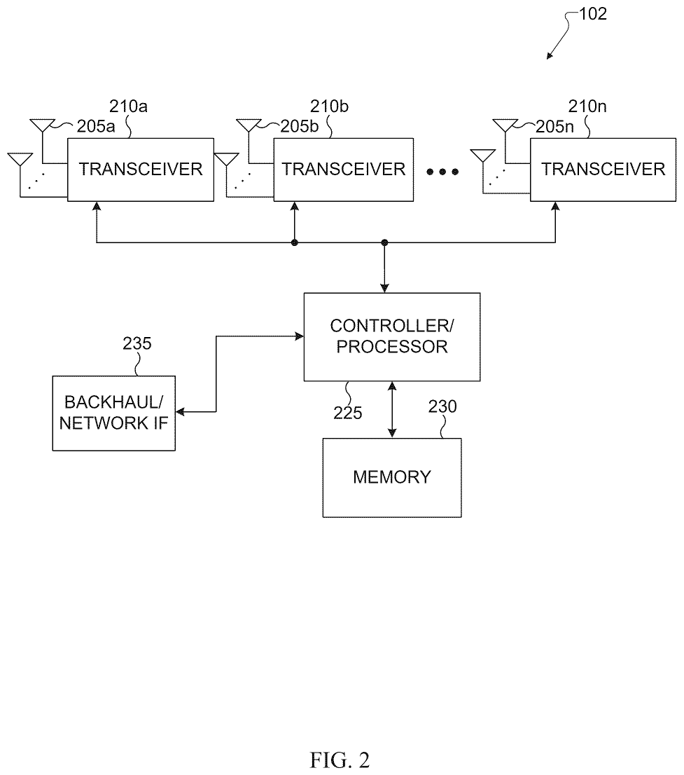

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting UE-initiated reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

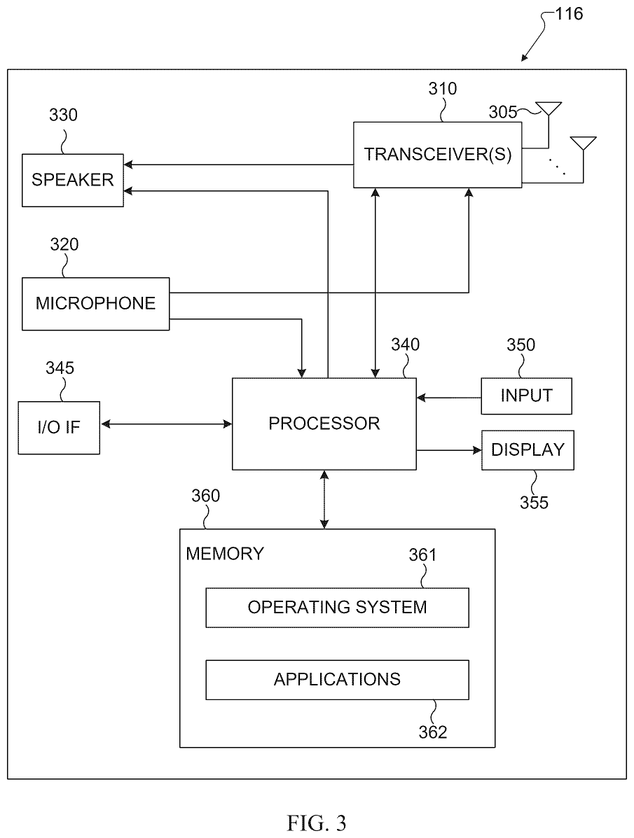

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify transmission of UE-initiated report as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

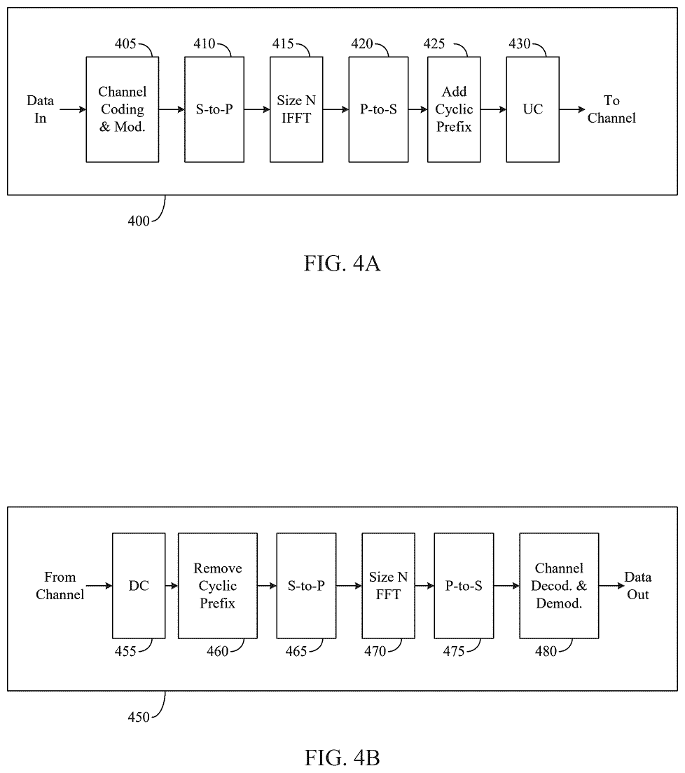

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 performs transmission of UE-initiated report as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

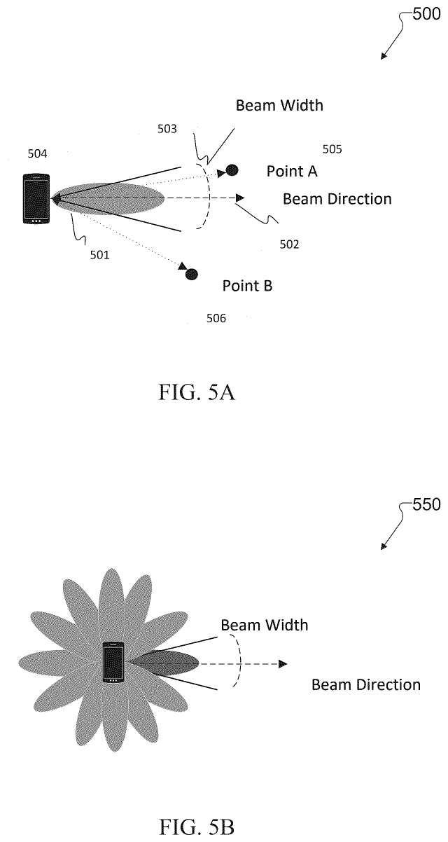

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

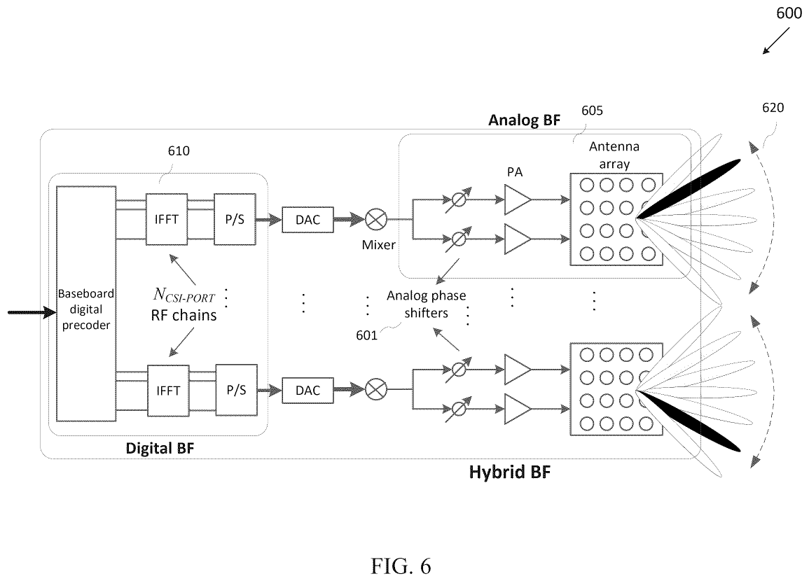

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of;
A transmission configuration indication (TCI) state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial RX filter for reception of downlink channels at the UE, or a spatial TX filter for transmission of uplink channels from the UE.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, embodiments of the present disclosure recognize that there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), and/or multiple event types when a report type can be associated with an event (e.g. for beam report, the event can be beam failure, and for CSI, the event can be user throughput degradation or increasing retransmission rate).

The present disclosure provides various aspects and detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents example embodiments on means of transmitting the UE-initiated report(s) along with its indicator(s) via various uplink channels.

In the present disclosure, a UE detects (or determines) a need for transmitting a UE-initiated/UE-triggered report (or initiation/triggering) of a (report-)type (A), (B), or (C), where:
(A) includes an initiator/trigger/pre-notification message
(B) includes a report/content (comprising one or multiple report quantities)
(C) includes both a trigger/pre-notification message and a (corresponding) report/content

The UE could send to the network the UE-initiated (UEI)/UE-triggered report of a (report-) type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is an beam (source RS) indicator (e.g. CRI, SSB resource indicator (SSBRI)) and Jᵢ is a beam metric (e.g. layer 1 reference signal received power (L1-RSRP), layer 1 signal-to-interference-plus-noise ratio (L1-SINR)).
In one example, the content includes CSI-related quantity/quantities. For example, at least one of rank indicator (RI), precoding matrix indicator (PMI), channel quality indicator (CQI), CQI report interval (CRI), layer index (LI).
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-) correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception and/or UL transmission), or
      antenna (e) (e.g. UE antennae for DL reception and/or UL transmission), or
      antenna port(s) (e.g. UE antenna ports for DL reception and/or UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception and/or UL transmission).
In one example, the content includes beam-related quantity/quantities (examples herein) and at least one other quantity/quantities (examples herein).
In one example, the content includes CSI-related quantity/quantities (examples herein) and at least one other quantity/quantities (examples herein).
In one example, the content includes TDCP-related quantity/quantities (examples herein) and at least one other quantity/quantities (examples herein).
In one example, the content includes beam-related quantity/quantities (examples herein) and CSI-related quantity/quantities (examples herein).
In one example, the content includes beam-related quantity/quantities (examples herein) and TDCP-related quantity/quantities (examples herein).
In one example, the content includes TDCP-related quantity/quantities (examples herein) and CSI-related quantity/quantities (examples herein).

In one example, the report is targeting a physical layer (L1) communication (e.g. L1 DL/UL, or L1 sidelink (SL)), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D), or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-) type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| Event type | Type | Trigger/pre-notification message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/ | (A) | Yes (e.g. non-CSI-related event) | No |
| beam/TDCP | (B) | No | Yes |
| | (C) | Yes (e.g. non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| | Trigger/ | |
|---|---|---|
| | pre- | |
| Report- | notification | |
| type | message | Content |
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), | No |
| | content-specific or | |
| | event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous
UE-initiated report
Report

| | Trigger/pre- | |
|---|---|---|
| | notification | |
| Type | message | Content |
| 0 | Yes (content- | No |
| | agnostic/ | |
| | transparent) | |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/remote radio head(s) (RRH(s)), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (cyclic delay diversity (CDD), cycling, space frequency block code (SFBC)), reciprocity (non-codebook (NCB), or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g. modulation and coding schemes (MCS), or number of CWs.
For another example, when there is no pre-notification message/trigger associated with a content, i.e., the report-type is (B), the content can be transmitted using UL resource(s) configured (e.g. configured-grant physical uplink shared channel (PUSCH)), or reserved for the UE-initiated report, or via a random access channel (RACH) procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC control element (CE) command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one embodiment, a UE (e.g., the UE 116) could send to the network one or more indicators/triggers or report quantities (e.g., in part of the content(s) in a (report-)type (B) based report or a (report-)type (C) based report) each comprising/including/containing or corresponding to one or more of:
An identity (ID) of the TCI state
An index/ID of a higher layer RRC configured list/set/pool of TCI states that comprises/indicates/provides the TCI state.
An index of the TCI state in a list/set/pool of TCI states higher layer RRC configured to the UE.
An index of the TCI state in a set of TCI states activated by a (unified) TCI state(s) activation/deactivation MAC CE
An index/ID of a set of TCI states—e.g., among sets of TCI states activated/provided by a (unified) TCI state(s) activation/deactivation MAC CE—that comprises/indicates/provides the TCI state
An index of the TCI state among TCI states mapped to a TCI codepoint activated/provided by a (unified) TCI state(s) activation/deactivation MAC CE
A TCI codepoint activated/provided by a (unified) TCI state(s) activation/deactivation MAC CE that comprises/indicates/provides the TCI state
An index/ID of a TCI codepoint—e.g., among TCI codepoints activated/provided by a (unified) TCI state(s) activation/deactivation MAC CE—that comprises/indicates/provides the TCI state
An index of the TCI state among TCI states indicated by a TCI codepoint of a TCI field in a beam indication DCI (e.g., DCI format 1_1/1_2 with or without DL assignment)
An index/ID of or information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received
An index/ID of or information related to a beam indication DCI that provides/indicates the TCI state or a TCI codepoint that comprises/indicates/provides the TCI state; the information could include/comprise/contain/indicate when (e.g., reception time in form of slot/slot index/etc.) the beam indication DCI was received
An index/ID of a CORESET or a coresetPoolIndex/coresetGroupIndex associated to a CORESET, in which a beam indication DCI that provides/indicates the TCI state or a TCI codepoint that comprises/indicates/provides the TCI state was received
RS index(es)/ID(s) such as SSB index(es)/ID(s) and/or CSI-RS resource index(es)/ID(s) provided/indicated in the TCI state along with the corresponding QCL-type(s)
Resource indicator(s) such as SSBRI(s) and/or CRI(s) reported in one or more CSI/beam reports
Beam metric(s) such as L1-RSRP(s) and/or L1-SINR(s) reported in one or more CSI/beam reports
Index(es)/ordering(s) of resource indicator(s) such as SSBRI(s) and/or CRI(s) among resource indicators such as SSBRIs and/or CRIs reported in one or more CSI/beam reports
Index(es)/ordering(s) of resource indicator(s) such as SSBRI(s) and/or CRI(s) among resource indicators such as SSBRIS and/or CRIs reported for TCI state(s)/beam(s) activation/deactivation/sub-selection as specified herein in the present disclosure in one or more CSI/beam reports
Index(es)/ordering(s) of resource indicator(s) such as SSBRI(s) and/or CRI(s) among candidate resource indicators such as SSBRIs and/or CRIs—as specified herein in the present disclosure—reported in one or more CSI/beam reports
Index(es)/ordering(s) of beam metric(s) such as L1-RSRP(s) and/or L1-SINR(s) among beam metrics such as L1-RSRPs and/or L1-SINRs reported in one or more beam/CSI reports
Index(es)/ordering(s) of beam metric(s) such as L1-RSRP(s) and/or L1-SINR(s) among beam metrics such as L1-RSRPs and/or L1-SINRs corresponding to resource indicators such as SSBRIs and/or CRIs reported for TCI state(s)/beam(s) activation/deactivation/sub-selection as specified herein in the present disclosure in one or more CSI/beam reports
Index(es)/ordering(s) of beam metric(s) such as L1-RSRP(s) and/or L1-SINR(s) among beam metrics such as L1-RSRPs and/or L1-SINRs corresponding to candidate resource indicators such as SSBRIs and/or CRIs—as specified herein in the present disclosure—reported in one or more CSI/beam reports
Group(s)/pair(s) of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported in one or more CSI/beam reports
Index(es)/ordering(s) of group(s)/pair(s) of resource indicators among groups/pairs of resource indicators such as SSBRIS and/or CRIs reported for TCI state(s)/beam(s) activation/deactivation/sub-selection as specified herein in the present disclosure in one or more CSI/beam reports
Index(es)/ordering(s) of group(s)/pair(s) of resource indicators among groups/pairs of candidate resource indicators such as SSBRIs and/or CRIs—as specified herein in the present disclosure—reported in one or more CSI/beam reports
Group(s)/pair(s) of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of resource indicators such as SSBRIs and/or CRIs reported for TCI state(s)/beam(s) activation/deactivation/sub-selection as specified herein in the present disclosure in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of candidate resource indicators such as SSBRIs and/or CRIs—as specified herein in the present disclosure-reported in one or more CSI/beam reports
A bitmap with each bit position of the bitmap corresponding to a candidate TCI state/TCI state ID/TCI state index/RS index or ID/resource indicator/etc. according to those specified herein in the present disclosure; for this case, when/if a bit position of the bitmap is set to ‘1’ (or ‘0’), the TCI state/TCI state ID/TCI state index/RS index or ID/resource indicator/etc. corresponding to the bit position could be for the UE-initiated beam(s)/TCI state(s) switching/update/change as specified herein in the present disclosure.

Throughout the present disclosure, an index could correspond to the “first”, the “second”, and etc. Furthermore, throughout the present disclosure, “trigger” can also be referred to as “initiate” or “indicate”; i.e., they can be used/applied to various design examples throughout the present disclosure interchangeably. For instance, the UE could send to the network an indicator to trigger a TCI state change/update/switch for one or more channels or signals. The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report.

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including physical uplink control channel(s) (PUCCH(s)), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

In one operation mode (Mode A), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.). In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂ K┘ or k=┌log₂ K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5: an uplink (scheduling) grant, e.g., for PUSCH(s)
   Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
   Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
      Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂ K┘ or k=┌log₂ K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
      Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
      Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-6f: one or more CSI reporting configuration/setting IDs/indexes—for the resource(s) not used/applicable/available for the second UL channel, wherein a CSI reporting setting/configuration is provided by CSI-ReportConfig.
      Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-6h: a starting symbol/slot/etc. for the resource(s) not used/applicable/available for the second UL channel
      Component-6i: an ending symbol/slot/etc. for resource(s) not used/applicable/available for the second UL channel
      Component-6j: a time duration/length (e.g., in form/terms/number of symbols/slot/etc.), within which the resources may not be used/applicable/available for the second UL channel
      Component-6k: a number of resources not used/available/applicable for the second UL channel
      Component-6l: an uplink (scheduling) grant, e.g., for PUSCH(s), such that the scheduled/granted resource(s) may not be used/available/applicable for the second UL channel
   Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
   Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.
One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling. which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH). In this step, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
   The (downlink/uplink) DCI (in Step-2) in response to the transmission of the PN message/trigger in Step-1 could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

In one operation mode (Mode B), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2); the UE could determine or identify the resource(s) for the second UL channel according to one or more of:
   In one example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

In one operation mode (Mode C), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂ K┘ or k=└log₂ K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)
   Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
   Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
      Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂ K┘ or k=┌log₂ K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
      Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
      Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-6f: one or more CSI reporting configuration/setting IDs/indexes—for the resource(s) not used/applicable/available for the second UL channel, wherein a CSI reporting setting/configuration is provided by CSI-ReportConfig.
      Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-6h: a starting symbol/slot/etc. for the resource(s) not used/applicable/available for the second UL channel
      Component-6i: an ending symbol/slot/etc. for resource(s) not used/applicable/available for the second UL channel
      Component-6j: a time duration/length (e.g., in form/terms/number of symbols/slot/etc.), within which the resources may not be used/applicable/available for the second UL channel
      Component-6k: a number of resources not used/available/applicable for the second UL channel
      Component-6l: an uplink (scheduling) grant, e.g., for PUSCH(s), such that the scheduled/granted resource(s) may not be used/available/applicable for the second UL channel
   Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
   Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.
One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the PN message/trigger in Step-1, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the PN message/trigger in Step-1, and/or when/if after the UE has transmitted or sent the PN message/trigger via the first UL channel in Step-1 but does not receive the (downlink/uplink) DCI in response to the PN message/trigger as specified or discussed in Step-2 a first time period/window/duration (e.g., denoted by t1 in terms/form/number of symbols/slots/etc.) after the first or last symbol/slot/etc. of the transmission of the PN message/trigger, and/or when/if after the UE has transmitted or sent the (same) PN message/trigger max_PN times/instances—each separated by a time gap-within a second time period/window/duration (e.g., denoted by t2 in terms/form/number of symbols/slots/etc.) but does not receive the (downlink/uplink) DCI in response to the last transmission time/instance of the (same) PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a third time period/window/duration (e.g., denoted by t3 in terms/form/number of symbols/slots/etc.) after the first or last symbol/slot/etc. of the transmission of the PN message/trigger. The value(s) of the max_PN, the time gap, the first, second and/or third time period(s)/window(s)/duration(s) t1, t2 and/or t3 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.): for example, the value(s) of t1, t2 and/or t3 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the PN message/trigger comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the PN message/trigger comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the PN message/trigger comprising one or more of the components including Component-1 (e.g., an ACK for the PN message/trigger), Component-2, Component-3 and/or Component-4 and/or Component-7 (i.e., except Component-5 and Component-6). For this design example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t2 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2 could be determined according to the time gap/duration provided/indicated in Component-2 and/or the time offset provided/indicated in Component-4 as/in part of the (downlink/uplink) DCI format in response to the PN message/trigger; for (iii), i.e., for the UE to autonomously determine or select the value(s) of the time period/window/duration t2 (e.g., in form/terms/number of slots/symbols/etc.): for example, the value(s) of t2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission does not indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the (downlink/uplink) DCI in response to the PN message/trigger is received p1 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel. The value(s) of p1, p2, t1 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q1 (in number of slots/symbols/etc.) earlier in time than the reception of the (downlink/uplink) DCI in response to the PN message/trigger, and/or when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, regardless of how/when the periodic/semi-persistent PUCCH resource(s) and/or the PUSCH resource(s) such as CG PUSCH of Type1 and/or Type2 is (pre-) configured by the network for transmitting or sending the UEI report content(s)/quantity(s) as defined or specified herein in the present disclosure, the UE could (always) determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel and/or the UE receives a (downlink/uplink) DCI in response to the PN message/trigger comprising at least an ACK (e.g., in Component-1) for the transmission of the PN message/trigger, regardless of whether or not the (downlink/uplink) DCI format in response to the PN message/trigger comprises or provides or indicates component(s)—e.g., Component-5 and/or Component-6 as defined/specified herein in the present disclosure—that provides or comprises or indicates resource allocation and/or indication for the second UL channel to carry or convey the UEI report content(s)/quantity(s) associated/specific to the PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
The (downlink/uplink) DCI (in Step-2) in response to the transmission of the PN message/trigger in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
   The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
   A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

Supporting Mode A (and/or Mode B and/or Mode C) and therefore the corresponding operations could be a basic UE feature such that when/if a UE supports the UE-initiated/event-driven beam reporting/management (or for a UE supporting the UE-initiated/event-driven beam reporting/management), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the UE-initiated/event-driven beam reporting/management; in this case, the UE could indicate to the network in their capability signaling(s) one or more of:
Support of Mode A and therefore the corresponding operations
Support of Mode B and therefore the corresponding operations
Support of Mode C and therefore the corresponding operations

That is, a UE's capability or capability signaling could comprise one or more components each indicating support of:
{Mode A}
{Mode B}
{Mode C}
{Mode A, Mode B}
{Mode A, Mode C}
{Mode B, Mode C}

For Mode A, Mode B and/or Mode C, after the UE has transmitted a PN message/trigger (or a first UEI report) via the first UL channel using one or more first (periodic) PUCCH resources in Step-1, the UE or higher layer(s) of the UE could start a transmission timer (e.g., length or duration of the transmission timer could be higher layer (RRC) configured or provided to the UE). Before the transmission timer expires, and/or before the UE could receive from the network a response in form of one or more of:
a (downlink/uplink) DCI in response to the PN message/trigger via the first UL channel providing an UL grant for transmitting the beam report (e.g., as in Step-2 in Mode A and/or Mode C); the CSI request field indicated/provided in the (downlink/uplink) DCI, e.g., DCI format 0_1, could be set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the CSI resource setting(s) provided by CSI-ResourceConfig(s) and/or CSI reporting setting(s) provided by CSI-ReportConfig(s) associated or specific or corresponding to CSI-AssociatedReportConfigInfo associated or specific or corresponding to the aperiodic CSI trigger state(s) indicated by the (value(s) of) CSI request field could be (dedicated) for the UE-initiated/event-driven beam reporting according to or following those specified herein in the present disclosure.
a (downlink/uplink) DCI triggering aperiodic CSI measurement and/or reporting and/or semi-persistent CSI reporting e.g. on PUSCH; the CSI request field indicated/provided in the (downlink/uplink) DCI, e.g., DCI format 0_1, could be set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the CSI resource setting(s) provided by CSI-ResourceConfig(s) and/or CSI reporting setting(s) provided by CSI-ReportConfig(s) associated or specific or corresponding to CSI-AssociatedReportConfigInfo associated or specific or corresponding to the aperiodic CSI trigger state(s) indicated by the (value(s) of) CSI request field could be for legacy CSI/beam measurement and/or reporting, i.e., not (dedicated) for the UE-initiated/event-driven beam reporting according to or following those specified herein in the present disclosure.
an activation/deactivation of semi-persistent CSI-RS/CSI-IM resource set MAC CE
an activation/deactivation of semi-persistent CSI reporting on PUCCH MAC CE
a TCI state update indicated by a beam indication DCI (e.g., via a TCI codepoint of the TCI field in the beam indication DCI of format 1_1/1_2 with or without DL assignment/grant) or a (unified) TCI state(s) activation/deactivation MAC CE (e.g., via a/the codepoint provided/indicated in the MAC CE); the TCI state update, or equivalently, the QCL RS (e.g., CSI-RS) or the RS (e.g., SSB) QCL'ed with the QCL RS (e.g., CSI-RS) indicated in the TCI state, could correspond to a beam (or equivalently a resource indicator and therefore, the corresponding RS) reported in the beam report
a beam indication DCI of format 1_1/1_2 with or without DL assignment/grant—the TCI field in the beam indication DCI provides or indicates a (valid) TCI codepoint providing or indicating a TCI state; the provided/indicated TCI state, or equivalently, the QCL RS (e.g., CSI-RS) or the RS (e.g., SSB) QCL'ed with the QCL RS (e.g., CSI-RS) indicated in the TCI state, could correspond to a beam (or equivalently a resource indicator and therefore, the corresponding RS) reported in the beam report
a (unified) TCI state(s) activation/deactivation MAC CE; at least one TCI state activated by/in the MAC CE, or equivalently, the QCL RS (e.g., CSI-RS) or the RS (e.g., SSB) QCL'ed with the QCL RS (e.g., CSI-RS) indicated in the at least one activated TCI state, could correspond to a beam (or equivalently a resource indicator and therefore, the corresponding RS) reported in the beam report
a beam failure recovery response (BFRR)
reception of a PDCCH in a search space set provided by ueInitiatedSearchSpaceId for which the UE could detect a DCI format with CRC scrambled by C-RNTI or MCS-C-RNTI, wherein the UE could be provided a CORESET through a link to a search space set provided by ueInitiatedSearchSpaceId, for monitoring PDCCH in the CORESET (e.g., for a PCell or a PSCell)
reception of a PDCCH that determines the completion of the contention based random access procedure
reception of a PDCCH with a DCI format scheduling a PUSCH transmission with a same HARQ process number as for the transmission of the PUSCH(s) used to carry the (second) UEI report(s)—e.g., as in Step-2 of Mode B and/or Step-3 of Mode A/C—and having a toggled NDI field value, the UE could (re-)transmit or (re-)send a/the same PN message/trigger (or the same first UEI report) via the first UL channel using one or more second (periodic) PUCCH resources according to or following those specified/defined herein in the present disclosure, wherein the second (periodic) PUCCH resource(s) could be separate or different from the first (periodic) PUCCH resources as aforementioned; in this case, when/if the number of (re-)transmissions of a/the same PN message/trigger (or the same first UEI report) via the first UL channel is equal to or larger than a maximum number of (re-)transmissions, e.g., denoted by pn-TransMax, higher layer (RRC) configured or provided to the UE, the UE or higher layer(s) of the UE could terminate, drop or stop transmission(s) of the corresponding PN message/trigger (or the corresponding first UEI report). Alternatively, when/if the transmission timer has expired or expires, and/or when/if the UE has received from the network a response in form of one or more of:
a (downlink/uplink) DCI in response to the PN message/trigger via the first UL channel providing an UL grant for transmitting the beam report (e.g., as in Step-2 in Mode A and/or Mode C); the CSI request field indicated/provided in the (downlink/uplink) DCI, e.g., DCI format 0_1, could be set to valid value(s)/index(es), e.g., pointing to the index(es) of the entries in CSI-Aperiodic TriggerStateList or the index(es) of the codepoint(s) in the aperiodic CSI trigger state subselection MAC CE. In this case, the CSI resource setting(s) provided by CSI-ResourceConfig(s) and/or CSI reporting setting(s) provided by CSI-ReportConfig(s) associated or specific or corresponding to CSI-AssociatedReportConfigInfo associated or specific or corresponding to the aperiodic CSI trigger state(s) indicated by the (value(s) of) CSI request field could be (dedicated) for the UE-initiated/event-driven beam reporting according to or following those specified herein in the present disclosure.
a (downlink/uplink) DCI triggering aperiodic CSI measurement and/or reporting and/or semi-persistent CSI reporting e.g. on PUSCH; the CSI request field indicated/provided in the (downlink/uplink) DCI, e.g., DCI format 0_1, could be set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the CSI resource setting(s) provided by CSI-ResourceConfig(s) and/or CSI reporting setting(s) provided by CSI-ReportConfig(s) associated or specific or corresponding to CSI-AssociatedReportConfigInfo associated or specific or corresponding to the aperiodic CSI trigger state(s) indicated by the (value(s) of) CSI request field could be for legacy CSI/beam measurement and/or reporting, i.e., not (dedicated) for the UE-initiated/event-driven beam reporting according to or following those specified herein in the present disclosure.
an activation/deactivation of semi-persistent CSI-RS/CSI-IM resource set MAC CE
an activation/deactivation of semi-persistent CSI reporting on PUCCH MAC CE
a TCI state update indicated by a beam indication DCI (e.g., via a TCI codepoint of the TCI field in the beam indication DCI of format 1_1/1_2 with or without DL assignment/grant) or a (unified) TCI state(s) activation/deactivation MAC CE (e.g., via a/the codepoint provided/indicated in the MAC CE); the TCI state update, or equivalently, the QCL RS (e.g., CSI-RS) or the RS (e.g., SSB) QCL'ed with the QCL RS (e.g., CSI-RS) indicated in the TCI state, could correspond to a beam (or equivalently a resource indicator and therefore, the corresponding RS) reported in the beam report
a beam indication DCI of format 1_1/1_2 with or without DL assignment/grant—the TCI field in the beam indication DCI provides or indicates a (valid) TCI codepoint providing or indicating a TCI state; the provided/indicated TCI state, or equivalently, the QCL RS (e.g., CSI-RS) or the RS (e.g., SSB) QCL'ed with the QCL RS (e.g., CSI-RS) indicated in the TCI state, could correspond to a beam (or equivalently a resource indicator and therefore, the corresponding RS) reported in the beam report
a (unified) TCI state(s) activation/deactivation MAC CE; at least one TCI state activated by/in the MAC CE, or equivalently, the QCL RS (e.g., CSI-RS) or the RS (e.g., SSB) QCL'ed with the QCL RS (e.g., CSI-RS) indicated in the at least one activated TCI state, could correspond to a beam (or equivalently a resource indicator and therefore, the corresponding RS) reported in the beam report
a beam failure recovery response (BFRR)
reception of a PDCCH in a search space set provided by ueInitiatedSearchSpaceId for which the UE could detect a DCI format with CRC scrambled by C-RNTI or MCS-C-RNTI, wherein the UE could be provided a CORESET through a link to a search space set provided by ueInitiatedSearchSpaceId, for monitoring PDCCH in the CORESET (e.g., for a PCell or a PSCell)
reception of a PDCCH that determines the completion of the contention based random access procedure
reception of a PDCCH with a DCI format scheduling a PUSCH transmission with a same HARQ process number as for the transmission of the PUSCH(s) used to carry the (second) UEI report(s)—e.g., as in Step-2 of Mode B and/or Step-3 of Mode A/C—and having a toggled NDI field value, the UE or higher layer(s) of the UE could terminate, drop or stop transmission(s) of the corresponding PN message/trigger (or the corresponding first UEI report).

According to those specified/defined herein in the present disclosure, a UEI report (or a first UEI report) could correspond to a PN message/trigger transmitted/sent via the first UL channel that comprises the one or more (periodic) PUCCH resources (in Mode A, Mode B and/or Mode C); or, a UEI report (or a first UEI report) could correspond to or could be referred to as the first UL channel, and therefore, the corresponding one or more (periodic) PUCCH resources (in Mode A, Mode B and/or Mode C) comprised therein.

According to those specified/defined herein in the present disclosure, a UEI report (or a second UEI report) could correspond to UEI report content(s)/quantity(s) as specified/defined herein in the present disclosure transmitted/sent via the second UL channel that comprises the one or more periodic/semi-persistent PUCCH resources (e.g., pre-configured by the network for sending the UEI report content(s)/quantity(s)) and/or the one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH) in Mode A, Mode B and/or Mode C; or, a UEI report (or a second UEI report) could correspond to or could be referred to as the second UL channel, and therefore, the corresponding one or more periodic/semi-persistent PUCCH resources (e.g., pre-configured by the network for sending the UEI report content(s)/quantity(s)) and/or the one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH) in Mode A, Mode B and/or Mode C comprised therein.

In the present disclosure, UE could be configured up to four sets of PUCCH resources in a PUCCH-Config. A PUCCH resource set is provided by PUCCH-ResourceSet and is associated with a PUCCH resource set index provided by pucch-ResourceSetId, with a set of PUCCH resource indexes provided by resourceList that provides a set of pucch-ResourceId used in the PUCCH resource set, and with a maximum number of uplink control information (UCI) information bits the UE can transmit using a PUCCH resource in the PUCCH resource set provided by maxPayloadSize. For the first PUCCH resource set, the maximum number of UCI information bits is 2. A maximum number of PUCCH resource indexes for a set of PUCCH resources is provided by maxNrofPUCCH-ResourcesPerSet. The maximum number of PUCCH resources in the first PUCCH resource set is 32 and the maximum number of PUCCH resources in the other PUCCH resource sets is 8. If the UE transmits O_{UCI} UCI information bits, that include hybrid automatic repeat request acknowledgement (HARQ-ACK) information bits and UEI report bits, the UE could determine a PUCCH resource set to be
a first set of PUCCH resources with pucch-ResourceSetId=0 if O_{UCI}≤2 including 1 or 2 HARQ-ACK information bits and a positive or negative SR on one SR transmission occasion and/or 1 or 2 UEI report bits if transmission of HARQ-ACK information and SR and/or UEI report occurs simultaneously, or
a second set of PUCCH resources with pucch-ResourceSetId=1, if provided by higher layers, if 2<O_{UCI}≤N₂ where N₂ is equal to maxPayloadSize if maxPayloadSize is provided for the PUCCH resource set with pucch-ResourceSetId=1; otherwise N₂ is equal to 1706, or
a third set of PUCCH resources with pucch-ResourceSetId=2, if provided by higher layers, if N₂<O_{UCI}≤N₃ where N₃ is equal to maxPayloadSize if maxPayloadSize is provided for the PUCCH resource set with pucch-ResourceSetId=2; otherwise N₃ is equal to 1706, or
a fourth set of PUCCH resources with pucch-ResourceSetId=3, if provided by higher layers, if N₃<O_{UCI}≤1706.

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UCI and etc. When the UE could use one or more PUCCH resources to transmit one or more UE-initiated (UEI) reports, which could comprise at least a pre-notification (PN) message in a (report-)type (A) based report or a (report-)type (C) based report according to those specified herein in the present disclosure and/or one or more indicators/triggers/report quantities in part of the content(s) in a (report-)type (B) based report or a (report-)type (C) based report according to those specified herein in the present disclosure,
In one example, the PUCCH resource(s) used to transmit the UEI report(s) could be fixed in system specification(s). For example, the UE could use the first PUCCH resource in the first set of PUCCH resources with pucch-ResourceSetId=1, if provided by higher layers, to transmit the UEI report(s).
In another example, the UE could be indicated/configured/provided by the network (e.g., based on/according to a corresponding UE's capability signaling), e.g., via higher layer RRC signaling(s)/parameter(s) and/or MAC CE command(s) and/or dynamic DCI based L1 signaling(s), one or more PUCCH resource indicators (PRIs) for or associated to transmitting the UEI report(s). For example, the UE could receive from the network, e.g., via higher layer RRC signaling(s)/parameter(s) and/or MAC CE command(s) and/or dynamic DCI based L1 signaling(s), one or more indications/configurations to enable the UE-initiated reporting specified herein in the present disclosure, wherein the one or more indications/configurations could also indicate/configure/provide the one or more PRIs for or associated to transmitting the UEI report(s).
In another example, the UE could be indicated/configured/provided by the network (e.g., based on/according to a corresponding UE's capability signaling), e.g., via higher layer RRC signaling(s)/parameter(s) and/or MAC CE command(s) and/or dynamic DCI based L1 signaling(s), one or more row indexes of a PUCCH resource configuration table with each row of the table associated/corresponding to one or more PUCCH resources, wherein the UE could be higher layer configured/provided by the network the table; for this case/design example, the UE could then identify or determine the PUCCH resource(s)—e.g., corresponding to the indicated/configured/provided row index(es) of the PUCCH resource configuration table—to transmit the UEI report(s). For example, the UE could receive from the network, e.g., via higher layer RRC signaling(s)/parameter(s) and/or MAC CE command(s) and/or dynamic DCI based L1 signaling(s), one or more indications/configurations to enable the UE-initiated reporting specified herein in the present disclosure, wherein the one or more indications/configurations could also indicate/configure/provide the one or more row indexes of the PUCCH resource configuration table.
In another example, the UE could be indicated/configured/provided by the network (e.g., based on/according to a corresponding UE's capability signaling), e.g., via higher layer RRC signaling(s)/parameter(s) and/or MAC CE command(s) and/or dynamic DCI based L1 signaling(s), information related to which PUCCH resource(s) to use for transmitting the UEI report(s).
   For example, the UE could be indicated/provided in a DCI format (e.g., DCI format 1_0, 1_1, etc.) one or more PRIs (each via a PUCCH resource indicator field in the corresponding DCI format) for determining the PUCCH resource(s) to use for transmitting uplink control information (UCI) including HARQ-ACK. For this case/design example, the UE could use the same one or more PRIs for determining which PUCCH resource(s) to use for transmitting the UEI report(s) described/specified herein in the present disclosure.
   For another example, the UE could be indicated/provided in a DCI format (e.g., DCI format 1_0, 1_1, etc.) one or more PRIs (each via a PUCCH resource indicator field in the corresponding DCI format), wherein the DCI format could be received the latest in time among DCI formats e.g. that indicate/provide PRI(s), and/or the DCI format could be the most recent applicable one among DCI formats e.g. that indicate/provide PRI(s). For this case/design example, upon receiving the one or more indicated/provided PRIs, the UE could use/apply them for determining which PUCCH resource(s) to use for transmitting the UEI report(s) described/specified herein in the present disclosure.
   For another example, the UE could be indicated/provided in a DCI format (e.g., DCI format 1_0, 1_1, etc.) one or more PRIs (each via a dedicated DCI field such as a dedicated PUCCH resource indicator field in the corresponding DCI format for the UEI reporting). For this case/design example, upon receiving the one or more indicated/provided PRIs, the UE could use/apply them for determining which PUCCH resource(s) to use for transmitting the UEI report(s) described/specified herein in the present disclosure. Furthermore, the PRI field(s) in the DCI format for the UEI reporting could be new/dedicated DCI field(s) introduced in the corresponding DCI format, which could be present or absent (e.g., a 0-bit field) depending on network's configuration(s)/indication(s) e.g. via higher layer RRC signaling(s)/parameter(s). Alternatively, the PRI field(s) in the DCI format for the UEI reporting could be existing DCI field(s)—e.g., the existing PRI field(s)—or could be by repurposing the existing DCI field(s)—e.g., by repurposing the existing PRI field(s).
   For another example, the UE could be first provided/configured/indicated by the network, e.g., via higher layer RRC signaling(s)/parameter(s), a list/set/pool of PRIs and/or PUCCH resources for the UEI reporting. For instance, the UE could receive from the network a RRC signaling/parameter/configuration to enable the UE-initiated reporting specified herein in the present disclosure, wherein the RRC signaling/parameter/configuration could also indicate/configure/provide the list/set/pool of PRIs and/or PUCCH resources for the UEI reporting. The UE could then receive from the network one or more indicators via one or more DCI fields in a DCI format (e.g., DCI format 1_0, 1_1, etc.), wherein the one or more DCI indicators could indicate which one or more of the PRIs (and therefore the corresponding PUCCH resources) and/or the PUCCH resources provided/configured/indicated in the list/set/pool of PRIs and/or PUCCH resources for the UEI reporting to use for transmitting the UEI report(s) described/specified herein in the present disclosure. In one example, for a list/set/pool of N PRIs and/or PUCCH resources higher layer configured/provided to the UE, a DCI field in a DCI format (e.g., DCI format 1_0, 1_1, etc.) used to indicate one or more PUCCH resources for transmitting the UEI report(s) could be of └log₂ N┘ bits—the presence/absence of the DCI field in the DCI format could be RRC configured; for instance, when/if the UE is not provided/configured by the network via higher layer RRC signaling the list/set/pool of PRIs and/or PUCCH resources (or equivalently, N=0) or when/if the UE is provided/configured by the network via higher layer RRC signaling a list/set/pool of one PRI/PUCCH resource (or equivalently, N=1), the DCI field as mentioned herein could be absent (i.e., a 0-bit field) in the corresponding DCI format—for this case, i.e., N=1, the UE could use/apply the PRI and/or the (corresponding) PUCCH resource provided/configured/indicated in the list/set/pool to determine the PUCCH resource to use for transmitting the UEI report(s) described/specified herein in the present disclosure. According to those specified herein in the present disclosure, the DCI field(s) in the DCI format used to indicate the PRI(s) and/or the (corresponding) PUCCH resource(s) for transmitting the UEI report(s) could be new/dedicated DCI field(s) introduced in the corresponding DCI format; alternatively, the DCI field(s) in the DCI format used to indicate the PRI(s) and/or the (corresponding) PUCCH resource(s) for transmitting the UEI report(s) could be existing DCI field(s)—e.g., the existing PRI field(s)—or could be by repurposing the existing DCI field(s)—e.g., by repurposing the existing PRI field(s). In addition, the DCI format could be received the latest in time among DCI formats e.g. that indicate/provide PRI(s) for transmitting uplink control information (UCI) including HARQ-ACK, and/or the DCI format could be the most recent applicable one among DCI formats e.g. that indicate/provide PRI(s) for transmitting uplink control information (UCI) including HARQ-ACK.
   For another example, the UE could be first provided/configured/indicated by the network, e.g., via higher layer RRC signaling(s)/parameter(s), a list/set/pool of N PRIs and/or PUCCH resources for the UEI reporting. For instance, the UE could receive from the network a RRC signaling/parameter/configuration to enable the UE-initiated reporting specified herein in the present disclosure, wherein the RRC signaling/parameter/configuration could also indicate/configure/provide the list/set/pool of N PRIs and/or PUCCH resources for the UEI reporting. The UE could then receive from the network a MAC CE activation command, activating one or more PRIs/PUCCH resources from the list/set/pool of PRIs and/or PUCCH resources higher layer configured/provided to the UE for the UE-initiated reporting, which could be used to map up to M DCI codepoints/indicators of one or more DCI fields in a DCI format (e.g., DCI format 1_0, 1_1, etc.). The UE could then receive from the network one or more DCI codepoints/indicators via the one or more DCI fields in the DCI format (e.g., DCI format 1_0, 1_1, etc.), wherein the one or more DCI indicators/codepoints could indicate which one or more of the PRIs (and therefore the corresponding PUCCH resources) and/or the PUCCH resources activated by/in the MAC CE activation command to use for transmitting the UEI report(s) described/specified herein in the present disclosure. In one example, for up to M PRIs and/or PUCCH resources that can be activated by/in the MAC CE activation command as described/specified herein in the present disclosure, a DCI field in a DCI format (e.g., DCI format 1_0, 1_1, etc.) used to indicate one or more PRIs/PUCCH resources for transmitting the UEI report(s) could be of └log₂ M┘ bits—the presence/absence of the DCI field in the DCI format could be RRC configured: for instance, when/if the UE is not provided/configured by the network via higher layer RRC signaling the list/set/pool of PRIs and/or PUCCH resources (or equivalently, N=0) or when/if the UE is provided/configured by the network via higher layer RRC signaling a list/set/pool of one PRI/PUCCH resource (or equivalently, N=1), the DCI field as mentioned herein could be absent (i.e., a 0-bit field) in the corresponding DCI format—for this case, i.e., N=1, the UE could use/apply the PRI and/or the (corresponding) PUCCH resource provided/configured/indicated in the list/set/pool to determine the PUCCH resource to use for transmitting the UEI report(s) described/specified herein in the present disclosure; optionally, when/if a single PRI/PUCCH resource is activated by/in the MAC CE activation command, the DCI field as mentioned herein could be absent (i.e., a 0-bit field) in the corresponding DCI format—for this case, i.e., M=1, the UE could use/apply the PRI and/or the (corresponding) PUCCH resource activated by/in the MAC CE activation command to determine the PUCCH resource to use for transmitting the UEI report(s) described/specified herein in the present disclosure. According to those specified herein in the present disclosure, the DCI field(s) in the DCI format used to indicate the PRI(s) and/or the (corresponding) PUCCH resource(s) for transmitting the UEI report(s) could be new/dedicated DCI field(s) introduced in the corresponding DCI format; alternatively, the DCI field(s) in the DCI format used to indicate the PRI(s) and/or the (corresponding) PUCCH resource(s) for transmitting the UEI report(s) could be existing DCI field(s)—e.g., the existing PRI field(s)—or could be by repurposing the existing DCI field(s)—e.g., by repurposing the existing PRI field(s). In addition, the DCI format could be received the latest in time among DCI formats e.g. that indicate/provide PRI(s) for transmitting uplink control information (UCI) including HARQ-ACK, and/or the DCI format could be the most recent applicable one among DCI formats e.g. that indicate/provide PRI(s) for transmitting uplink control information (UCI) including HARQ-ACK.
In another example, if configured/enabled by the network subject to a corresponding UE's capability signaling, a UE (e.g., the UE 116) could autonomously determine/select one or more PUCCH resources (e.g., from one or more PUCCH resource sets), and use/apply their determined/selected one or more PUCCH resources to transmit the UEI report(s). For this case/design example, the UE could also inform the network their determined/selected one or more PUCCH resources for transmitting the UEI report(s) in form/terms of, e.g., their PRIs in the corresponding PUCCH resource set(s). For this case/design example, the UE could send to the network their determined/selected one or more PUCCH resources for transmitting the UEI report(s) in form/terms of, e.g., their PRIs in the corresponding PUCCH resource set(s) via/in part of the UEI report(s) and/or by multiplexing them with UCI information including HARQ-ACK and/or by multiplexing them with SR and/or CSI/beam report(s). In addition, the UE could also inform or send to the network information related to the corresponding PUCCH resource set(s) in form/terms of, e.g., their corresponding PUCCH resource set IDs/indexes via/in part of the UEI report(s) and/or by multiplexing them with UCI information including HARQ-ACK and/or by multiplexing them with SR and/or CSI/beam report(s).

According to those specified herein in the present disclosure, a UEI report in the described design examples herein could comprise at least a pre-notification message/trigger—e.g., of (report-) type (A) or (report-)type (C) as specified herein in the present disclosure. Furthermore, after the UE has determined or identified one or more PRIs according to one or more of the described design examples herein, the UE could determine a PUCCH resource on the cell of the PUCCH transmission, after determining a set of PUCCH resources for O_{UEI} UEI report bits, based on the determined/identified one or more PRIs. Furthermore, a UE could transmit a first UEI report via one or more PUCCH resources determined according to one or more examples described herein, wherein the first UEI report could comprise at least a pre-notification message/trigger—e.g., of (report-)type (A) or (report-)type (C) as specified herein in the present disclosure. After the UE has sent to the network the first UEI report, the UE could expect to receive from the network, within a time window, a dynamic signaling including a MAC CE command or a DCI format indicating one or more PRIs according to one or more examples described herein for the UE to determine the PUCCH resource(s) used for transmitting a second UEI report, wherein the second UEI report could comprise at least the content(s)—e.g., of (report-)type (B) or (report-)type (C) as specified herein in the present disclosure comprising one or more of the indicators/triggers or the report quantities as specified herein in the present disclosure. Here, the time window could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc. According to those specified herein in the present disclosure, the first UEI report and the second UEI report could be associated/linked, e.g., the pre-notification message in the first UEI report could indicate to the network a transmission of the corresponding content(s) in the second UEI report—as specified herein in the present disclosure, they can be in the same transmission/transmission occasion/report (e.g., via a same set of uplink resources including PUCCH(s) and/or PUSCH(s)) or they can be in separate transmissions/transmission occasions/reports (e.g., via different sets of uplink resources including PUCCH(s) and/or PUSCH(s)).
In one example, the UE could transmit the first/second UEI report(s) as a UCI that has two parts (part 1 UCI and part 2 UCI). For this case/example, the UE could transmit the first UEI report(s) in part 1 of the two-part UCI, and the second UEI report(s) in part 2 of the two-part UCI. The first UEI report(s) in the part 1 UCI could indicate whether or not the second UEI report(s) is present (or absent) in the part 2 UCI. Optionally, the first UEI report(s) in the part 1 UCI could be of fixed payload size, which could also indicate/provide information related to the payload size of the second UEI report(s) in the part 2 UCI (if present). For this case/design example, by transmitting the first UEI report(s) and the second UEI report(s) in respective part 1 and part 2 of a single UCI, they become associated/linked such that the pre-notification message in the first UEI report could indicate to the network a transmission of the corresponding content(s) in the second UEI report.
In another example, the first UEI report could include/contain/comprise a first entity ID, and the second UEI report could include/contain/comprise a second entity ID. When/if the first entity ID and the second entity ID are identical/the same, the first UEI report and the second UEI report could be associated/linked, such that, the pre-notification message in the first UEI report could indicate to the network a transmission of the corresponding content(s) in the second UEI report.
In another example, the second (or first) UEI report could include/contain/comprise an entity ID associated to the first (or second) UEI report. For instance, the second UEI report could include/contain/comprise the report ID of the first UEI report; alternatively, the second UEI report could include/contain/comprise the pre-notification/trigger ID of the pre-notification message/trigger in the first UEI report. For this case/design example, the first and second UEI reports are associated/linked such that the pre-notification message in the first UEI report could indicate to the network a transmission of the corresponding content(s) in the second UEI report.
In another example, the UE could be indicated/provided/configured by the network, e.g., via higher layer RRC signalling/parameter and/or MAC CE command and/or dynamic DCI based L1 signalling, whether or not a first UEI report could be associated/linked to a second UEI report such that the pre-notification message in the first UEI report could indicate to the network a transmission of the corresponding content(s) in the second UEI report.
In another example, when/if a first UEI report and a second UEI report are transmitted/received within a time window, they (i.e., the first and second UEI reports) are associated/linked to each other such that the pre-notification message in the first UEI report could indicate to the network a transmission of the corresponding content(s) in the second UEI report. For this design example, the time window could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc.
In another example, when/if a second UEI report is transmitted/received within a time window starting from the last symbol/slot of the transmission/reception of the first UEI report, they (i.e., the first and second UEI reports) are associated/linked to each other such that the pre-notification message in the first UEI report could indicate to the network a transmission of the corresponding content(s) in the second UEI report. For this design example, the time window could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc.
In another example, according to or following those specified herein in the present disclosure, a UE could determine or identify a PUCCH resource of the first UL channel as in Step-1 of Mode A, Mode B and/or Mode C to transmit a PN message/trigger (or a first UEI report). Furthermore, the UE could determine or identify a PUSCH resource of the second UL channel e.g. as in Step-2 of Mode B to transmit a beam report or UEI report content(s)/quantity(s)—or a second UEI report, wherein the PUSCH resource could be linked/associated/mapped to the PUCCH resource. In this design example, the PUCCH resource and the PUSCH resource could be within a time window and/or separated/apart from each other by at least X symbol(s)/slot(s), and the UE could identify or determine the value(s), length(s), duration(s) and etc. of the time window and/or X according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s) based on or subject to a corresponding UE's capability or capability signaling, and/or (iii) UE's autonomous determination/selection, which could be further sent to the network via/in part of the UEI report(s), beam/CSI report(s) and/or etc. Furthermore, the PN message/trigger (or the first UEI report) transmitted/sent via/on/in the PUCCH resource could also be associated/linked/mapped to the beam report/UEI report content(s)/quantity(s)—or the second UEI report—transmitted/sent via/on/in the PUSCH resource.
In another example, according to or following those specified herein in the present disclosure, a UE could determine or identify a PUCCH resource of the first UL channel as in Step-1 of Mode A, Mode B and/or Mode C to transmit a PN message/trigger (or a first UEI report). Furthermore, the UE could determine or identify a PUSCH resource of the second UL channel e.g. as in Step-2 of Mode B to transmit a beam report or UEI report content(s)/quantity(s)—or a second UEI report, wherein the PUSCH resource could be linked/associated/mapped to the PUCCH resource. In this design example, the first (or last) symbol/slot of the PUSCH resource could be within a time window starting from and/or at least X symbol(s)/slot(s) after the last (or first) symbol/slot of the PUCCH resource, and the UE could identify or determine the value(s), length(s), duration(s) and etc. of the time window and/or X according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s) based on or subject to a corresponding UE's capability or capability signaling, and/or (iii) UE's autonomous determination/selection, which could be further sent to the network via/in part of the UEI report(s), beam/CSI report(s) and/or etc. Furthermore, the PN message/trigger (or the first UEI report) transmitted/sent via/on/in the PUCCH resource could also be associated/linked/mapped to the beam report/UEI report content(s)/quantity(s)—or the second UEI report—transmitted/sent via/on/in the PUSCH resource.

In addition, the PN message sent by the UE (in part of the first UEI report) or the first UEI report could indicate or provide to the network information related to the payload/report size the second UEI report. For instance, the UE could first determine/identify a set of M candidate payload/report size values for the second UEI report, wherein the M candidate payload/report size values could be: (i) fixed values in system specification(s), (ii) configured/provided/indicated by the network, e.g., via higher layer RRC signaling(s)/parameter(s) and/or MAC CE command(s) and/or dynamic DCI based L1 signaling(s), and/or (iii) autonomously determined/selected by the UE, which could be further sent to the network via/in part of the UEI report(s), beam/CSI report(s) and/or etc. For instance, the PN sent in part of the first UEI report by the UE could indicate/provide/inform to the network that the payload/report size of the second UEI report could correspond to the m-th candidate payload/report size value out of the M candidate payload/report size values, i.e., m∈{1, . . . , M}).
For example, the PN message sent in part of the first UEI report could be a └log₂ M┘-bit indicator, with each state of the └log₂ M┘-bit indicator corresponding/associated to one of the M candidate payload/report size values for the second UEI report; when/if a state of the └log₂ M┘-bit indicator is sent by the UE in form of the PN message, the UE indicates/provides/informs to the network that the candidate payload/report size value associated/corresponding to the state could be the actual payload/report size of the second UEI report. For instance, for M=2, the PN message could be a 1-bit indicator with ‘0’ (or ‘1’) indicating/providing/informing to the network that the first candidate report/payload size value could be the actual payload/report size of the second UEI report, and ‘1’ (or ‘0’) indicating/providing/informing to the network that the second candidate payload/report size value could be the actual payload/report size of the second UEI report. For this case/design example, the UE could send the PN message (i.e., the └log₂ M┘-bit indicator) in part of the first UEI report indicating the state associated/corresponding to the m-th candidate payload/report size value.
For another example, the PN message sent in part of the first UEI report could be a multi-bit indicator with └log₂ M┘ most significant bits (MSBs)/least significant bits (LSBs) used to indicate or provide to the network information related to the payload/report size the second UEI report. Each state of the └log₂ M┘ MSBs/LSBs could be associated to one of the M candidate payload/report size values for the second UEI report; when/if a state of the └log₂ M┘ MSBs/LSBs is sent by the UE in part of the PN message, the UE indicates/provides/informs to the network that the candidate payload/report size value associated/corresponding to the state could be the actual payload/report size of the second UEI report. For instance, for M=2, the MSB/LSB of the PN message could be ‘0’ (or ‘1’) indicating/providing/informing to the network that the first candidate report/payload size value could be the actual payload/report size of the second UEI report, and ‘1’ (or ‘0’) indicating/providing/informing to the network that the second candidate payload/report size value could be the actual payload/report size of the second UEI report. For this case/design example, the UE could send the PN message in part of the first UEI report indicating a state of the └log₂ M┘ MSBs/LSBs associated/corresponding to the m-th candidate payload/report size value.
For another example, the PN message sent in part of the first UEI report could be a length-M bitmap with each entry/bit position of the bitmap corresponding/associated to one of the M candidate payload/report size values for the second UEI report. When/if an entry/bit position of the bitmap is set to ‘1’ (or ‘0’), the UE indicates/provides/informs to the network that the candidate payload/report size value associated/corresponding to the entry/bit position in the bitmap could be the actual payload/report size of the second UEI report. For this case/design example, at least the entry/bit position (e.g., the m-th entry/bit position) of the bitmap/PN message sent by the UE in part of the first UEI report that is associated/corresponding to the m-th candidate payload/report size value could be set to ‘1’ (or ‘0’).
For another example, payload size of the PN message (or report size of the first UEI report) could be used to indicate or provide to the network information related to the payload/report size the second UEI report. For instance, when/if the payload size of the PN message (or the report size of the first UEI report) is greater than (or less than) a threshold/level (e.g., the m-th threshold/level for this case), the UE indicates/provides/informs to the network that the candidate payload/report size value (e.g., the m-th candidate payload/report size value for this case) associated/corresponding to the threshold/level (e.g., the m-th threshold/level for this case) could be the actual payload/report size of the second UEI report. The value of the threshold/level (e.g., the m-th threshold/level for this case) could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc.

In one embodiment, a UE could be configured up to four sets of PUCCH resources in a PUCCH-Config. A PUCCH resource set is provided by PUCCH-ResourceSet and is associated with a PUCCH resource set index provided by pucch-ResourceSetId, with a set of PUCCH resource indexes provided by resourceList that provides a set of pucch-ResourceId used in the PUCCH resource set, and with a maximum number of UCI information bits the UE can transmit using a PUCCH resource in the PUCCH resource set provided by maxPayloadSize. For the first PUCCH resource set, the maximum number of UCI information bits is 2. A maximum number of PUCCH resource indexes for a set of PUCCH resources is provided by maxNrofPUCCH-ResourcesPerSet. The maximum number of PUCCH resources in the first PUCCH resource set is 32 and the maximum number of PUCCH resources in the other PUCCH resource sets is 8. If the UE transmits O_{UCI} UCI information bits, that include HARQ-ACK information bits and UEI report bits, the UE could determine a PUCCH resource set to be
a first set of PUCCH resources with pucch-ResourceSetId=0 if O_{UCI}≤2 including 1 or 2 HARQ-ACK information bits and a positive or negative SR on one SR transmission occasion and/or 1 or 2 UEI report bits if transmission of HARQ-ACK information and SR and/or UEI report occurs simultaneously, or
a second set of PUCCH resources with pucch-ResourceSetId=1, if provided by higher layers, if 2<O_{UCI}≤N₂ where N₂ is equal to maxPayloadSize if maxPayloadSize is provided for the PUCCH resource set with pucch-ResourceSetId=1; otherwise N₂ is equal to 1706, or
a third set of PUCCH resources with pucch-ResourceSetId=2, if provided by higher layers, if N₂<O_{UCI}≤N₃ where N₃ is equal to maxPayloadSize if maxPayloadSize is provided for the PUCCH resource set with pucch-ResourceSetId=2; otherwise N₃ is equal to 1706, or
a fourth set of PUCCH resources with pucch-ResourceSetId=3, if provided by higher layers, if N₃<O_{UCI}≤1706.

In one example, the UE could inform or send to the network information related to the determined PUCCH resource set(s) according to those specified herein in the present disclosure, e.g., in form/terms of their corresponding PUCCH resource set IDs/indexes via/in part of the UEI report(s) and/or by multiplexing them with UCI information including HARQ-ACK and/or by multiplexing them with SR and/or CSI/beam report(s).

In one embodiment, a UE could be provided/configured/indicated by the network, e.g., via higher layer RRC signaling(s)/parameter(s) and/or MAC CE command(s) and/or dynamic DCI based L1 signaling(s), one or more configured grant (CG) PUSCH configurations for the UEI reporting. For instance, the UE could be provided by the network K CG PUSCH configurations for the UEI reporting each provided by ConfiguredGrantConfig with a CG configuration ID denoted by cgConfigId.
In one example, the CG PUSCH resource(s) used to transmit the UEI report(s) could be fixed in system specification(s). For example, the UE could use the PUSCH resources provided/configured in/by the first CG PUSCH configuration provided by ConfiguredGrantConfig with cgGrantConfig=1, if provided by higher layers, to transmit the UEI report(s).
In another example, the UE could be indicated/configured/provided by the network (e.g., based on/according to a corresponding UE's capability signaling), e.g., via higher layer RRC signaling(s)/parameter(s) and/or MAC CE command(s) and/or dynamic DCI based L1 signaling(s), which one or more of the provided/indicated/configured K CG PUSCH configurations could be used to transmit the UEI report(s). For instance, the UE could be indicated/configured/provided by the network (e.g., based on/according to a corresponding UE's capability signaling), e.g., via higher layer RRC signaling(s)/parameter(s) and/or MAC CE command(s) and/or dynamic DCI based L1 signaling(s), that at least the k-th CG PUSCH configuration (out of the provided/indicated/configured K CG PUSCH configurations, i.e., k∈{1, . . . , K}) could be used to transmit the UEI report(s).
   For example, the UE could receive from the network, e.g., via higher layer RRC signaling(s)/parameter(s) and/or MAC CE command(s) and/or dynamic DCI based L1 signaling(s), one or more indications/configurations to enable the UE-initiated reporting specified herein in the present disclosure, wherein the one or more indications/configurations could also indicate/configure/provide to the UE that at least the k-th CG PUSCH configuration (out of the provided/indicated/configured K CG PUSCH configurations, i.e., k∈{1, . . . , K}) could be used to transmit the UEI report(s).
   For another example, at least the higher layer parameter ConfiguredGrantConfig that configures/provides the k-th CG PUSCH configuration with cgConfigId=k (and/or the corresponding MAC CE command(s) and/or dynamic DCI based L1 signaling(s)) could include/contain/provide/configure/comprise a higher layer parameter for UeInitiatedReporting (or set to ‘enabled’), and/or a one-bit indicator set to ‘1’ (or ‘0’).
   For another example, the UE could be provided/configured/indicated in the higher layer parameter (and/or the corresponding MAC CE command(s) and/or dynamic DCI based L1 signaling(s)) that provides/configures/indicates the K CG PUSCH configurations a bitmap of length K with each entry/bit position of the bitmap associated/corresponding one of the K CG PUSCH configurations. For this case/design example, at least the entry/bit position (e.g., the k-th entry/bit position) of the bitmap that is associated/corresponding to the k-th CG PUSCH configuration could be set to ‘1’ (or ‘0’).
   For another example, the UE could receive from the network one or more indicators via one or more DCI fields in a DCI format (e.g., DCI format 1_0, 1_1, 1_2, 0_0, 0_1, 0_2, etc.), wherein the one or more DCI indicators could indicate/provide/configure to the UE that at least the k-th CG PUSCH configuration (out of the provided/indicated/configured K CG PUSCH configurations, i.e., k∈{1, . . . , K}) could be used to transmit the UEI report(s). In one example, for a total of K CG PUSCH configurations higher layer configured/provided to the UE, a DCI field in a DCI format (e.g., DCI format 1_0, 1_1, 1_2, 0_0, 0_1, 0_2, etc.) used to indicate which of the CG PUSCH resource(s)/configuration(s) for transmitting the UEI report(s) could be of └log₂ K┘ bits—the presence/absence of the DCI field in the DCI format could be RRC configured; for instance, when/if the UE is not provided/configured by the network via higher layer RRC signaling the candidate CG PUSCH configurations for the UEI reporting (or equivalently, K=0) or when/if the UE is provided/configured by the network via higher layer RRC signaling a single CG PUSCH configuration for the UEI reporting (or equivalently, K=1), the DCI field as mentioned herein could be absent (i.e., a 0-bit field) in the corresponding DCI format—for this case, i.e., K=1, the UE could use/apply the provided/configured/indicated CG PUSCH configuration—and therefore, the PUSCH resource(s) provided/indicated/configured therein—to transmit the UEI report(s) described/specified herein in the present disclosure. According to those specified herein in the present disclosure, the DCI field(s) in the DCI format used to indicate the CG PUSCH configuration(s) for transmitting the UEI report(s) could be new/dedicated DCI field(s) introduced in the corresponding DCI format; alternatively, the DCI field(s) in the DCI format used to indicate the CG PUSCH configuration(s) for transmitting the UEI report(s) could be existing DCI field(s) or could be by repurposing the existing DCI field(s). In addition, the DCI format could be received the latest in time among DCI formats e.g. that indicate/provide PRI(s) for transmitting uplink control information (UCI) including HARQ-ACK, and/or the DCI format could be the most recent applicable one among DCI formats e.g. that indicate/provide PRI(s) for transmitting uplink control information (UCI) including HARQ-ACK.
   For another example, the UE could receive from the network a MAC CE activation command, activating one or more CG PUSCH configurations from the total K CG PUSCH configurations higher layer configured/provided to the UE for the UE-initiated reporting, which could be used to map up to P DCI codepoints/indicators of one or more DCI fields in a DCI format (e.g., DCI format 1_0, 1_1, 1_2, 0_0, 0_1, 0_2, etc.). The UE could then receive from the network one or more DCI codepoints/indicators via the one or more DCI fields in the DCI format (e.g., DCI format 1_0, 1_1, 1_2, 0_0, 0_1, 0_2, etc.), wherein the one or more DCI indicators/codepoints could indicate/provide/configure to the UE that at least the k-th CG PUSCH configuration (out of the provided/indicated/configured K CG PUSCH configurations, i.e., k∈{1, . . . , K}) could be used to transmit the UEI report(s). In one example, for up to P CG PUSCH configurations that can be activated by/in the MAC CE activation command as described/specified herein in the present disclosure, a DCI field in a DCI format (e.g., DCI format 1_0, 1_1, 1_2, 0_0, 0_1, 0_2, etc.) used to indicate which of the CG PUSCH resource(s)/configuration(s) for transmitting the UEI report(s) could be of └log₂ P┘ bits—the presence/absence of the DCI field in the DCI format could be RRC configured: for instance, when/if the UE is not provided/configured by the network via higher layer RRC signaling the candidate CG PUSCH configurations for the UEI reporting (or equivalently, K=0) or when/if the UE is provided/configured by the network via higher layer RRC signaling a single CG PUSCH configuration for the UEI reporting (or equivalently, K=1), the DCI field as mentioned herein could be absent (i.e., a 0-bit field) in the corresponding DCI format—for this case, i.e., K=1, the UE could use/apply the provided/configured/indicated CG PUSCH configuration—and therefore, the PUSCH resource(s) provided/indicated/configured therein—to transmit the UEI report(s) described/specified herein in the present disclosure; optionally, when/if a single CG PUSCH configuration is activated by/in the MAC CE activation command, the DCI field as mentioned herein could be absent (i.e., a 0-bit field) in the corresponding DCI format—for this case, i.e., P=1, the UE could use/apply the CG PUSCH configuration—and therefore, the CG PUSCH resource(s) provided/configured therein—activated by/in the MAC CE activation command to determine the PUCCH resource to use for transmitting the UEI report(s) described/specified herein in the present disclosure. According to those specified herein in the present disclosure, the DCI field(s) in the DCI format used to indicate the CG PUSCH configuration(s) for transmitting the UEI report(s) could be new/dedicated DCI field(s) introduced in the corresponding DCI format; alternatively, the DCI field(s) in the DCI format used to indicate the CG PUSCH configuration(s) for transmitting the UEI report(s) could be existing DCI field(s) or could be by repurposing the existing DCI field(s). In addition, the DCI format could be received the latest in time among DCI formats e.g. that indicate/provide PRI(s) for transmitting uplink control information (UCI) including HARQ-ACK, and/or the DCI format could be the most recent applicable one among DCI formats e.g. that indicate/provide PRI(s) for transmitting uplink control information (UCI) including HARQ-ACK.
In another example, a UE could transmit a first UEI report, wherein the first UEI report could comprise at least a pre-notification (PN) message/trigger—e.g., of (report-)type (A) or (report-)type (C) as specified herein in the present disclosure, and a second UEI report, wherein the second UEI report could comprise at least the content(s)—e.g., of (report-)type (B) or (report-)type (C) as specified herein in the present disclosure—comprising one or more of the indicators/triggers or the report quantities as specified herein in the present disclosure, corresponding/associated/linked to the first UEI report according to those specified herein in the present disclosure. For this case/design example, the PN message sent by the UE (in part of the first UEI report) could indicate to the network which one or more of the provided/indicated/configured K CG PUSCH configurations could be used to transmit the second UEI report. For instance, the PN sent in part of the first UEI report by the UE could indicate/provide/inform to the network that at least the k-th CG PUSCH configuration (out of the provided/indicated/configured K CG PUSCH configurations, i.e., k∈{1, . . . , K}) could be used to transmit the second UEI report.
   For example, the PN message sent in part of the first UEI report could be a └log₂ K┘-bit indicator, with each state of the └log₂ K┘-bit indicator corresponding/associated to one of the provided/indicated/configured K CG PUSCH configuration; when/if a state of the └log₂ K┘-bit indicator is sent by the UE in form of the PN message, the UE indicates/provides/informs to the network that at least the CG PUSCH configuration associated/corresponding to the state could be used for transmitting the second UEI report. For instance, for K=2, the PN message could be a 1-bit indicator with ‘0’ (or ‘1’) indicating/providing/informing to the network that at least the first CG PUSCH configuration could be used for transmitting the second UEI report, and ‘1’ (or ‘0’) indicating/providing/informing to the network that at least the second CG PUSCH configuration could be used for transmitting the second UEI report. For this case/design example, the UE could send the PN message (i.e., the └log₂ K┘-bit indicator) in part of the first UEI report indicating the state associated/corresponding to the k-th CG PUSCH configuration.
   For another example, the PN message sent in part of the first UEI report could be a multi-bit indicator with └log₂ K┘ MSBs/LSBs used to indicate/inform to the network which one or more of the provided/indicated/configured K CG PUSCH configurations could be used to transmit the second UEI report. Each state of the └log₂ K┘ MSBs/LSBs could be associated to one of the provided/indicated/configured K CG PUSCH configuration; when/if a state of the └log₂ K┘ MSBs/LSBs is sent by the UE (e.g., the UE 116) in part of the PN message, the UE indicates/provides/informs to the network that at least the CG PUSCH configuration associated/corresponding to the state could be used for transmitting the second UEI report. For instance, for K=2, the MSB/LSB of the PN message could be ‘0’ (or ‘1’) indicating/providing/informing to the network that at least the first CG PUSCH configuration could be used for transmitting the second UEI report, and ‘1’ (or ‘0’) indicating/providing/informing to the network that at least the second CG PUSCH configuration could be used for transmitting the second UEI report. For this case/design example, the UE could send the PN message in part of the first UEI report indicating a state of the └log₂ K┘ MSBs/LSBs as the one associated/corresponding to the k-th CG PUSCH configuration.
   For another example, the PN message sent in part of the first UEI report could be a length-K bitmap with each entry/bit position of the bitmap corresponding/associated to one of the K CG PUSCH configurations. When/if an entry/bit position of the bitmap is set to ‘1’ (or ‘0’), the UE indicates/provides/informs to the network that at least the CG PUSCH configuration associated/corresponding to the entry/bit position in the bitmap could be used for transmitting the second UEI report. For this case/design example, at least the entry/bit position (e.g., the k-th entry/bit position) of the bitmap/PN message sent by the UE in part of the first UEI report that is associated/corresponding to the k-th CG PUSCH configuration could be set to ‘1’ (or ‘0’).
   For another example, payload size of the PN message (or report size of the first UEI report) could be used to indicate/inform to the network which one or more of the provided/indicated/configured K CG PUSCH configurations could be used to transmit the second UEI report. For instance, when/if the payload size of the PN message (or the report size of the first UEI report) is greater than (or less than) a threshold/level (e.g., the k-th threshold/level for this case), the UE indicates/provides/informs to the network that at least the CG PUSCH configuration (e.g., the k-th CG PUSCH configuration for this case) associated/corresponding to the threshold/level (e.g., the k-th threshold/level for this case) could be used for transmitting the second UEI report. The value of the threshold/level (e.g., the k-th threshold/level for this case) could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc.

For the design examples specified/described herein in the present disclosure,
In one example, when/if the provided/configured/indicated CG PUSCH configuration(s) corresponds to Type-2 CG PUSCH configuration(s), after the UE has sent to the network at least the first UEI report (or the PN message in the first UEI report), the UE could start transmitting the second UEI report on the PUSCH resource(s) determined/selected according to those specified herein in the present disclosure. That is, for Type-2 CG PUSCH transmission(s) in this case/design example, the UE may not expect to receive a DCI with or addressed to configured scheduling radio network temporary identifier (CS-RNTI) to trigger or indicate the transmission(s) on the CG PUSCH resource(s); the first UEI report or the PN message in the first UEI report could serve as the same role as the DCI with or addressed to CS-RNTI to trigger or indicate the transmission(s) on the CG PUSCH resource(s).
In another example, for both Type-1 and Type-2 CG PUSCH configurations, after the UE has sent to the network at least the first UEI report (or the PN message in the first UEI report), the UE could expect or it is expected that the UE could transmit the second UEI report on the earliest available/applicable PUSCH resource(s) determined/selected according to those specified herein in the present disclosure.

The described/specified design examples related to the determination of the CG PUSCH configuration(s)/resource(s) to use for transmitting the UEI report(s) throughput the present disclosure are applicable for both Type-1 and Type-2 CG PUSCH transmissions.

In one embodiment, a UE could transmit a first UEI report, wherein the first UEI report could comprise at least a pre-notification (PN) message/trigger—e.g., of (report-)type (A) or (report-) type (C) as specified herein in the present disclosure, and a second UEI report, wherein the second UEI report could comprise at least the content(s)—e.g., of (report-)type (B) or (report-)type (C) as specified herein in the present disclosure—comprising one or more of the indicators/triggers or the report quantities as specified herein in the present disclosure, corresponding/associated/linked to the first UEI report according to those specified herein in the present disclosure. After the UE has sent to the network the first UEI report (or the PN message in the first UEI report), the UE could expect to be provided/configured/indicated by the network within a time window, e.g., via higher layer RRC signaling(s)/parameter(s) and/or MAC CE command(s) and/or dynamic DCI based L1 signaling(s), one or more configured grant (CG) PUSCH configurations for the UEI reporting, wherein each of the CG PUSCH configurations for the UEI reporting could be provided by ConfiguredGrantConfig with a CG configuration ID denoted by cgConfigId. The UE could then determine/identify the CG PUSCH configuration(s)—and therefore, the PUSCH resource(s) provided/configured therein—for transmitting at least the second UEI report. The time window could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc.

In one embodiment, the UEI reporting as specified herein in the present disclosure could be disabled or turned off according to one or more of:
In one example, the UEI reporting as specified herein in the present disclosure could be disabled or turned off based on certain or fixed rule(s) in system specification(s). For example, the UEI reporting could be disabled or turned off when/if the time window starting from the last symbol/slot of transmitting the UEI report(s) is greater than a threshold, wherein the threshold could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc. For another example, the UEI reporting could be disabled or turned off when/if a UEI reporting timer is reset or expires, wherein the UE could start the UEI reporting timer when the UE has started to transmit the UEI report(s). For this case/design example, the value of the UEI reporting timer could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc.
In another example, the UE could be provided/configured/indicated by the network (e.g., according to a corresponding UE's capability signaling), e.g., via higher layer RRC signaling(s)/parameter(s) and/or MAC CE command(s) and/or dynamic DCI based L1 signaling(s), to disable or turn of the UEI reporting as specified herein in the present disclosure.
   For example, the UE could receive from the network a higher layer RRC parameter/configuration to turn off or disable the UEI reporting. In one example, the UE could be provided/configured by the network a higher layer RRC parameter/configuration ueInitiatedReporting set to ‘disabled’. In another example, the UE could be provided/configured by the network in CSI-ReportConfig, the higher layer parameter reportQuantity set to certain specific value(s) and/or value(s) other than ‘none’.
   For another example, the UE could receive from the network a MAC CE deactivation command to deactivate, turn off or disable the UEI reporting.
   For another example, the UE could be indicated by the network via dynamic DCI signaling(s) to turn off or disable the UEI reporting. In one example, when/if the UE receives in DCI format 1_0, a certain DCI field set to certain value(s), e.g., the CSI request field set to valid value(s)/index(es), e.g., pointing to the index(es) of the entries in CSI-Aperiodic TriggerStateList or the index(es) of the codepoint(s) in the aperiodic CSI trigger state subselection MAC CE, the UE could turn off or disable the UEI reporting according to those specified herein in the present disclosure.
In another example, the UE could send to the network one or more indicators to turn off or disable or deactivate the UEI reporting as specified herein in the present disclosure. For instance, the one or more indicators could be sent as or in form/part of the UEI report(s) according to those specified herein in the present disclosure—e.g., as or in form/part of a pre-notification (PN) message/trigger—e.g., of (report-)type (A) or (report-)type (C) as specified herein in the present disclosure, and/or as or in part/form of the content(s)—e.g., of (report-)type (B) or (report-)type (C) as specified herein in the present disclosure. For this case, the UE could determine the uplink resource(s) used for sending the one or more indicators to turn off or disable or deactivate the UEI reporting according to/based on those specified herein in the present disclosure.

In one embodiment, if a UE would transmit a single PUSCH scheduled by a DCI format that includes a downlink assignment index (DAI) field on a serving cell in a slot with reference to slots for PUCCH transmissions without any other PUSCH that would be transmitted on any serving cell in the slot and the UE does not determine any PUCCH carrying HARQ-ACK information in the slot, or if the UE indicates the corresponding capability mux-HARQ-ACK-withoutPUCCH-onPUSCH and the UE transmits multiple PUSCHs on respective serving cells in a slot with reference to slots for PUCCH transmissions and the UE does not determine any PUCCH carrying HARQ-ACK information in the slot and at least one of the multiple PUSCHs is scheduled by a DCI format that includes a DAI field, the UE selects the single PUSCH or the multiple PUSCHs in the slot as the candidate PUSCHs for HARQ-ACK multiplexing within the slot except for the single PUSCH or any PUSCH among the multiple PUSCHs that is scheduled by a DCI format that includes a DAI field that is equal to 4 in case the UE is configured with pdsch-HARQ-ACK-Codebook=dynamic or with pdsch-HARQ-ACK-Codebook-r16, or is equal to 0 in case the UE is configured with pdsch-HARQ-ACK-Codebook=semi-static if the size of the DAI fields for unicast or for unicast physical downlink shared channel (PDSCH) reception is no/not larger or greater than 2, else,
the value indicated by the first DAI field [5, TS 38.212] [REF2] is equal to 0 if the size of the first DAI field is 1 bit; else, each value indicated by the first DAI field is equal to 4, and,
each value indicated by the second DAI field [5, TS 38.212] [REF2] is equal to 4, if any, and
the value indicated by the third DAI field [5, TS 38.212] [REF2] is equal to 0 if the size of the third DAI field is 1 bit, else, the value of DAI indicated by the third DAI field is equal to 4, if any.

One or more of the specified conditions herein, steps and/or procedures could be configured, enabled, indicated or provided by the network, e.g., via higher layer RRC signaling(s)/parameter(s) and/or MAC CE command(s) and/or dynamic DCI based L1 signaling(s) according to or based on a corresponding UE's capability or capability signaling.

In one embodiment, if a UE would transmit a single PUSCH scheduled by a DCI format that includes a DAI field on a serving cell in a slot with reference to slots for PUCCH transmissions without any other PUSCH that would be transmitted on any serving cell in the slot and the UE does not determine any PUCCH carrying HARQ-ACK information in the slot, or if the UE indicates the corresponding capability mux-HARQ-ACK-withoutPUCCH-onPUSCH and the UE transmits multiple PUSCHs on respective serving cells in a slot with reference to slots for PUCCH transmissions and the UE does not determine any PUCCH carrying HARQ-ACK information in the slot and at least one of the multiple PUSCHs is scheduled by a DCI format that includes a DAI field, the UE selects the single PUSCH or the multiple PUSCHs in the slot as the candidate PUSCHs for HARQ-ACK multiplexing within the slot except for the single PUSCH or any PUSCH among the multiple PUSCHs that is scheduled by a DCI format that includes a DAI field that is equal to 4 in case the UE is configured with pdsch-HARQ-ACK-Codebook=dynamic or with pdsch-HARQ-ACK-Codebook-r16, or is equal to 0 in case the UE is configured with pdsch-HARQ-ACK-Codebook=semi-static if the size of the DAI fields is no larger than 2, else,
the value indicated by the first DAI field [5, TS 38.212] [REF2] is equal to 0 if the size of the first DAI field is 1 bit; else, each value indicated by the first DAI field is equal to 4, and,
each value indicated by the second DAI field [5, TS 38.212] [REF2] is equal to 4, if any.

One or more of the specified conditions herein, steps and/or procedures could be configured, enabled, indicated or provided by the network, e.g., via higher layer RRC signaling(s)/parameter(s) and/or MAC CE command(s) and/or dynamic DCI based L1 signaling(s) according to or based on a corresponding UE's capability or capability signaling.

In one embodiment, if a UE would transmit a single PUSCH scheduled by a DCI format that includes a DAI field on a serving cell in a slot with reference to slots for PUCCH transmissions without any other PUSCH that would be transmitted on any serving cell in the slot and the UE does not determine any PUCCH carrying HARQ-ACK information in the slot, or if the UE indicates the corresponding capability mux-HARQ-ACK-withoutPUCCH-onPUSCH and the UE transmits multiple PUSCHs on respective serving cells in a slot with reference to slots for PUCCH transmissions and the UE does not determine any PUCCH carrying HARQ-ACK information in the slot and at least one of the multiple PUSCHs is scheduled by a DCI format that includes a DAI field, the UE selects the single PUSCH or the multiple PUSCHs in the slot as the candidate PUSCHs for HARQ-ACK multiplexing within the slot except for the single PUSCH or any PUSCH among the multiple PUSCHs that is scheduled by a DCI format that includes a DAI field that is equal to 4 in case the UE is configured with pdsch-HARQ-ACK-Codebook=dynamic or with pdsch-HARQ-ACK-Codebook-r16, or is equal to 0 in case the UE is configured with pdsch-HARQ-ACK-Codebook=semi-static if the DCI format indicates (or includes) one (or only) DAI value, if the total number of bits for DAI fields for unicast is no larger than 2, else,
the value of DAI indicated by the 1^{st} DAI field [5, TS 38.212] [REF2] is equal to 0 if the number of bits for the 1^{st} DAI field is 1 bit, else, the value of each DAI indicated by the 1^{st} DAI field is equal to 4, and,
the value of each DAI indicated by the 2^{nd} DAI field [5, TS 38.212] [REF2] is equal to 4, if any, and
the value of DAI indicated by the 3^{rd} DAI field [5, TS 38.212] [REF2] is equal to 0 if the number of bits for the 3^{rd} DAI field is 1 bit, else, the value of DAI indicated by the 3^{rd} DAI field is equal to 4, if any.

One or more of the specified conditions herein, steps and/or procedures could be configured, enabled, indicated or provided by the network, e.g., via higher layer RRC signaling(s)/parameter(s) and/or MAC CE command(s) and/or dynamic DCI based L1 signaling(s) according to or based on a corresponding UE's capability or capability signaling.

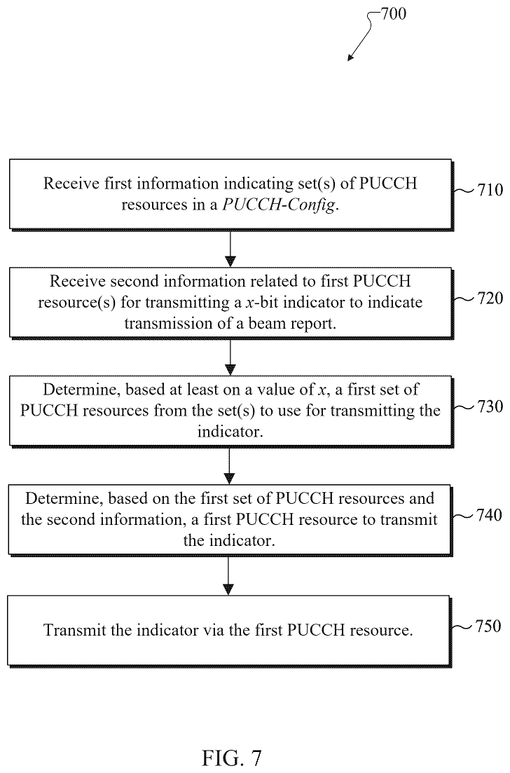

FIG. 7 illustrates an example method 700 performed by a UE in a wireless communication system according to embodiments of the present disclosure. The method 700 of FIG. 7 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method 700 begins with the UE receiving first information indicating set(s) of PUCCH resources in a PUCCH-Config (710). In 710, each of the set(s) is associated with a pucch-ResourceSetId. The UE then receives second information related to first PUCCH resource(s) for transmitting a x-bit indicator to indicate transmission of a beam report (720). In various embodiments, the second information is via a RRC signaling and indicates resource IDs or indexes, a periodicity, and an offset.

The UE then determines, based at least on a value of x, a first set of PUCCH resources from the set(s) to use for transmitting the indicator (730). In various embodiments, when x=1 or 2 and a number of UCI bits is less than or equal to 2, the first set of PUCCH resources is associated with pucch-ResourceSetId=0. In various embodiments, each codepoint of the x-bit indicator corresponds to at least one of a candidate payload size for the beam report and a candidate resource configuration for second PUSCH resource(s) for transmitting the beam report.

The UE then determines, based on the first set of PUCCH resources and the second information, a first PUCCH resource to transmit the indicator (740). In various embodiments, the UE receives, via a DCI signaling, a PRI and determines the first PUCCH resource also based on the PRI. The UE then transmits the indicator via the first PUCCH resource (750). In 750,

In various embodiments, the UE receives third information related to second PUSCH resource(s) for transmitting the beam report, receives fourth information related to association between transmissions of the indicator and the beam report, determines, based on the third information, the first PUCCH resource and the fourth information, a second PUSCH resource to transmit the beam report, and transmits, via the second PUSCH resource, the beam report. In some examples, the third information is via a RRC signaling and indicates resource IDs or indexes, a periodicity, an offset, and an offset relative to the first PUCCH resource(s). In some examples, the fourth information indicates a time window and, when the first PUCCH resource and the second PUSCH resource are within the time window or the second PUSCH resource is within the time window starting from a last symbol of the first PUCCH resource, the transmissions of the indicator and the beam report are associated.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information indicating one or more sets of physical uplink control channel (PUCCH) resources in a PUCCH-Config, wherein each of the one or more sets is associated with a pucch-ResourceSetId; and
receive second information related to one or more first PUCCH resources for transmitting a x-bit indicator to indicate transmission of a beam report, wherein x≥1; and
a processor operably coupled with the transceiver, the processor configured to:
determine, based at least on a value of x, a first set of PUCCH resources from the one or more sets to use for transmitting the indicator; and
determine, based on the first set of PUCCH resources and the second information, a first PUCCH resource to transmit the indicator,
wherein the transceiver is further configured to transmit, via the first PUCCH resource, the indicator.

2. The UE of claim 1, wherein, when x=1 or 2 and a number of uplink control information (UCI) bits is less than or equal to 2, the first set of PUCCH resources is associated with pucch-ResourceSetId=0.

3. The UE of claim 1, wherein:
the second information is via a radio resource control (RRC) signaling, and
the second information indicates resource identifiers (IDs) or indexes, a periodicity, and an offset.

4. The UE of claim 1, wherein:
the transceiver is further configured to receive, via a downlink control information (DCI) signaling, a PUCCH resource indicator (PRI); and
the processor is further configured to determine, based on the PRI, the first PUCCH resource.

5. The UE of claim 1, wherein:
the transceiver is further configured to:
receive third information related to one or more second physical uplink shared channel (PUSCH) resources for transmitting the beam report; and
receive fourth information related to association between transmissions of the indicator and the beam report;
the processor is further configured to determine, based on the third information, the first PUCCH resource and the fourth information, a second PUSCH resource to transmit the beam report; and
the transceiver is further configured to transmit, via the second PUSCH resource, the beam report.

6. The UE of claim 5, wherein:
the third information is via a radio resource control (RRC) signaling, and
the third information indicates resource identifiers (IDs) or indexes, a periodicity, an offset, and an offset relative to the one or more first PUCCH resources.

7. The UE of claim 5, wherein:
the fourth information indicates a time window; and
when (i) the first PUCCH resource and the second PUSCH resource are within the time window or (ii) the second PUSCH resource is within the time window starting from a last symbol of the first PUCCH resource, the transmissions of the indicator and the beam report are associated.

8. The UE of claim 1, wherein each codepoint of the x-bit indicator corresponds to at least one of:
a candidate payload size for the beam report, and
a candidate resource configuration for one or more second physical uplink shared channel (PUSCH) resources for transmitting the beam report.

9. A base station (BS), comprising:
a processor; and
a transceiver operably coupled with the processor, the transceiver configured to:
transmit first information indicating one or more sets of physical uplink control channel (PUCCH) resources in a PUCCH-Config, wherein each of the one or more sets is associated with a pucch-ResourceSetId;
transmit second information related to one or more first PUCCH resources for a x-bit indicator to indicate a beam report, wherein x≥1; and
receive, via a first PUCCH, the indicator,
wherein a first set of PUCCH resources from the one or more sets for the indicator is based on a value of x, and
wherein the first PUCCH resource for the indicator is based on the first set of PUCCH resources and the second information.

10. The BS of claim 9, wherein, when x=1 or 2 and a number of uplink control information (UCI) bits is less than or equal to 2, the first set of PUCCH resources is associated with pucch-ResourceSetId=0.

11. The BS of claim 9, wherein:
the second information is via a radio resource control (RRC) signaling, and
the second information indicates resource identifiers (IDs) or indexes, a periodicity, and an offset.

12. The BS of claim 9, wherein:
the transceiver is further configured to transmit, via a downlink control information (DCI) signaling, a PUCCH resource indicator (PRI); and
the first PUCCH resource is further based on the PRI.

13. The BS of claim 9, wherein:
the transceiver is further configured to:
transmit third information related to one or more second physical uplink shared channel (PUSCH) resources for the beam report; and
transmit fourth information related to association between receptions of the indicator and the beam report;
a second PUSCH resource for the beam report is based on the third information, the first PUCCH resource and the fourth information; and
the transceiver is further configured to receive, via the second PUSCH resource, the beam report.

14. The BS of claim 13, wherein:
the third information is via a radio resource control (RRC) signaling, and
the third information indicates resource identifiers (IDs) or indexes, a periodicity, an offset, and an offset relative to the one or more first PUCCH resources.

15. The BS of claim 13, wherein:
the fourth information indicates a time window; and
when (i) the first PUCCH resource and the second PUSCH resource are within the time window or (ii) the second PUSCH resource is within the time window starting from a last symbol of the first PUCCH resource, the receptions of the indicator and the beam report are associated.

16. The BS of claim 9, wherein each codepoint of the x-bit indicator corresponds to at least one of:
a candidate payload size for the beam report, and
a candidate resource configuration for one or more second physical uplink shared channel (PUSCH) resources for the beam report.

17. A method performed by a user equipment (UE), the method comprising:
receiving first information indicating one or more sets of physical uplink control channel (PUCCH) resources in a PUCCH-Config, wherein each of the one or more sets is associated with a pucch-ResourceSetId;
receiving second information related to one or more first PUCCH resources for transmitting a x-bit indicator to indicate transmission of a beam report, wherein x≥1;
determining, based at least on a value of x, a first set of PUCCH resources from the one or more sets to use for transmitting the indicator;
determining, based on the first set of PUCCH resources and the second information, a first PUCCH resource to transmit the indicator; and
transmitting, via the first PUCCH resource, the indicator.

18. The method of claim 17, wherein, when x=1 or 2 and a number of uplink control information (UCI) bits is less than or equal to 2, the first set of PUCCH resources is associated with pucch-ResourceSetId=0.

19. The method of claim 17, wherein:
the second information is via a radio resource control (RRC) signaling, and
the second information indicates resource identifiers (IDs) or indexes, a periodicity, and an offset.

20. The method of claim 17, further comprising:
receiving, via a downlink control information (DCI) signaling, a PUCCH resource indicator (PRI),
wherein determining the first PUCCH resource further comprises determining the first PUCCH resource based on the PRI.
